(19) United States
(12) Patent Application Publication
(10) Pub. No.: US 2009/0201617 A1
(43) Pub. Date: Aug. 13, 2009

(54) CIRCUIT BREAKER

(75) Inventor: Sataro YAMAGUCHI, Kasugai-shi (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHA Y.Y.L., Tokyo (JP)

(21) Appl. No.: 12/187,030

(22) Filed: Aug. 6, 2008

(30) Foreign Application Priority Data
Feb. 7, 2008 (JP) 2008-027616

(51) Int. Cl. H02H 9/02

(52) U.S. Cl. 361/93.9

(57) ABSTRACT

Disclosed is a current-limiting circuit breaker including first and second mechanical switches connected in series with each other, a first diode, and a first snubber circuit, each connected in parallel across both ends of the first mechanical switch, and a second diode, and a second snubber circuit, each connected in parallel across both ends of the second mechanical switch.

### REFERENCE TO RELATED APPLICATION

This application is based upon and claims the benefit of the priority of Japanese patent application No. 2008-027616, filed on Feb. 7, 2008 claiming the priorities of JP Patent Application No. 2007-28285 filed on Feb. 7, 2007 and No. 2007-74446 filed on Mar. 22, 2007, the disclosure of which is incorporated herein in its entirety by reference thereto.

### TECHNICAL FIELD

This invention relates to a circuit breaker.

### BACKGROUND

A current-limiting circuit breaker which suppresses the current in case of failure in a power system, to less than a certain value, is classified into an active type and a passive type.

The passive type automatically detects the fault current and restores the normal operating state. The active type uses a sensor and actuates the current-limiting circuit breaker by a control signal.

Representative of the current-limiting circuit breakers are an arc driving type, a semiconductor switch type, an LC resonance type, and a rectifier type, in addition to the type exploiting superconductivity. It should be noted that, although the current-limiting circuit breaker is aimed to limit the fault current, it is ultimately necessary to break the circuit, and hence the current-limiting circuit breaker preferably includes the circuit breaking function.

FIG. 7 shows an example of an arc driving type current-limiting interrupting unit (cited from page 8 of a Technical Report of the Institutes of Electrical Engineers, No. 1053, ‘Specifications Required of Current Limiting Circuit Breaker and Techniques for its Evaluation), edited by the Experts Committee for Technical Researches for Fault Detection, May 2006; the original thesis being Ichikawa et al., ‘Field Test of Arc Driving Type Current Limiting Circuit Breaker for 6.6 kV Distribution Line’, No. 342, B-Section Meeting of the Institutes of Electrical Engineers, 2001).

A switch (high-speed commutation switch) is opened for arc ignition between resistive parallel electrodes. Arc plasma is caused to travel at a high speed, by a magnetic field generated by the current flowing through an arc and the current flowing through the electrodes, thereby suppressing the current. In the configuration shown in FIG. 7, the switch (high-speed commutation switch) may thus be actuated at a high speed of 200 us (micro-second). The current-limiting action may thus be initiated from the first wave. To extinguish the arc, the switch part is mounted in general in a hermetically sealed vessel which is charged with an insulating gas, such as an SF6 gas or a nitrogen gas. Turning to the current state of development, an apparatus with 6.6 kV/400 A (three phase) and shorting capacity of 150 MVA is tentatively produced, and a test is now conducted on this prototype device.

FIG. 8 illustrates an exemplary configuration of the semiconductor type (FIG. 12 of Patent Publication 1, a Technical Report of the Institutes of Electrical Engineers, No. 1053, entitled ‘Specifications Required of Current limiting Circuit Breaker and Techniques for its Evaluation’, page 9, edited by the Experts Committee for Technical Researches for Fault Detection, May 2006; the original thesis being a Technical Report of the Institutes of Electrical Engineers, No. 850, entitled ‘Applied techniques and Analytic Evaluation of Current Limiting Devices for Suppressing Fault Current’, page 4, 2001).

The configuration of FIG. 8 includes a compound structure composed of a mechanical vacuum valve (vacuum circuit breaker VCB), also termed a vacuum interrupter, and a semiconductor switch, such as a GTO thyristor. This configuration is also termed as ‘compound semiconductor type’. There is also a parallel two-winding type reactor compound system, besides the configuration shown in FIG. 8.

The operation of the current-limiting circuit breaker of FIG. 8 is now described. The current normally flows through the mechanical switch (VCB). On outbreak of a system failure, the short-circuiting current is detected, and the VCB is opened, thus generating an arc across the electrodes. At the same time, a trigger signal is introduced to a semiconductor switch, such as SCR (thyristor) or GTO (gate turn-off thyristor), thereby turning the semiconductor switch on. Since the ON voltage of the semiconductor switch (=several volts) is lower than the voltage of the arc plasma of the VCB (scores of volts), the current is transferred from the VCB to the semiconductor switch. The current transfer time depends on the resistance and the inductance of the circuit and on the difference between the arc voltage and the ON voltage. It should be noted that the arc voltage is varied promptly with time and, if observed with e.g. an oscilloscope, the voltage may appear to be a sort of a spike noise. This is ascribable to instable arc plasma generated across the VCB electrodes. When the VCB current is decreased by commutation and becomes lower than a certain threshold value, the current is acutely decreased until the current flowing through the VCB is equal to zero. This completes the process of commutation, and the current flows in its entirety through the semiconductor switch.

The semiconductor switch is classified into a ‘self-extinguishing’ type device and a ‘non-self-extinguishing’ type device’. The former type may be exemplified by a GTP, and the latter by an SCR.

If, in the self-extinguishing type device, the trigger signal is interrupted, the function of interrupting the current comes into play. However, the energy of the current flowing at such time through the circuit needs to be absorbed in its entirety by the device, inclusive of the snubber circuit, thus occasionally damaging the device. The snubber circuit therefore needs to be designed as the device characteristics are taken into account.

With the non-self-extinguishing type device, the device per se does not have the function of interrupting the current. However, if no trigger signal is introduced at the time of zero crossing caused by reversion of the a.c. current, there ceases current flow from that time point, by way of performing the current interruption. This phenomenon may be likened to the rectifying action by the diode.

If the current ceases to flow through the VCB and the semiconductor switch, the fault current flows in its entirety through an over-voltage suppressing device or the current-limiting impedance of FIG. 8. The high impedance suppresses the fault current, thus producing the current-limiting action.

As a similar type of the current-limiting circuit breaker, there is a genuine semiconductor type device constituted solely by a semiconductor switch without use of VCBs. With this semiconductor type device, the current flows at all times through the semiconductor switch and, when the semiconductor switch ceases to be supplied with a trigger signal, the current interrupting operations are initiated. The current then transfers to the current-limiting impedance, by way of producing the current-limiting action.

The ON voltage of GTO or SCR is on the order of 2.5V to 3.5V, while the ON voltage of the mechanical switch VCB is on the order of scores of mV. It is therefore necessary to dissipate heat from the semiconductor switch, thus increasing the size of the device and power loss of the transmission network. If the size of the device used for the semiconductor switch is increased, the cost is increased. This is the principal reason why the parallel connection of the semiconductor switch (VCB) with the mechanical switch is used.

As a self-extinguishing type device, there is such a device employing a power MOSFET or IGBT (insulated gate bipolar transistor). This device allows for a high speed switching operation and has a low ON voltage.

The device of this type has a feature that, if SiC (silicon carbide) is used as a semiconductor material, heat dissipation units are not needed. However, the power MOSFET or IGBT has a withstand voltage lower than in GTO or SCR, and accommodates only a small current. Hence, the application of the power MOSFET or IGBT to control of a large power is a matter that might be tackled with only in future.

In addition, development of a system in which the fault current is suppressed by exploiting a superconducting material is going on. With this system, the fault current is suppressed by increasing the impedance of a circuit for the large current, by exploiting the phenomenon of S/N transition between the superconducting state and the normal conducting state.

This system has a feature that it is an active type current-limiting circuit breaker which may be in operation at a high speed and which is not in need of detecting an accident. However, the system suffers from large power consumption due to use of a refrigerator to maintain the superconducting state, and from the consequent high cost, so that there is currently no favorable prospect for using the device.

FIG. 9 shows a cross-sectional structure of an arc extinguishing part of an air circuit breaker, appearing in p. 755 of ‘Handbook of Electrical Engineering’, Institutes of Electrical Engineers, sixth edition, 2001. This device is not a current-limiting circuit breaker but is in use extensively at present. The air circuit breaker has a rated current of 200 A to 6 kA and a rated interrupting current of 5 kA to 125 kA. This sort of the air circuit breaker has a significant feature that it has not only the circuit breaking function but also the current-limiting function through the arc extinguishing operation of the arc plasma. When the circuit breaking operation is initiated, the switch part is opened, so that an arc is generated across the electrodes. Arc plasma impinges on a partitioning wall or fin of FIG. 9 and a dia-ion grid of FIG. 9. It is because the arc plasma is blown off by an electromagnetic force generated by a magnetic field produced by the arc current itself, the magnetic field generated by the blowout coil, and by the arc plasma current.

The partitioning wall is formed of iron and is used in a structure shown in FIG. 9 for a low voltage device for home use or for a device up to A.C. 600V. If arc plasma impinges on a partitioning wall, the arc is quenched quickly, so that its temperature decreases. The arc plasma is increased in resistance, at the same time as it is cooled, so that the amount of the current carriers is decreased due to recombination of ions and electrons in the plasma, with the resistance increasing sharply. As a result, the ON voltage increases quickly, thus demonstrating the current-limiting action.

The specified configuration of the device is shown herein in FIG. 10, which drawing is recited from page 756 of the ‘Handbook of Electrical Engineering, sixth edition. The device detects the fault current and performs the circuit breaking action at a high speed (in one half cycle to one complete cycle). The operating time is less than one-tenth of that with VCB, with the operating speed being higher by nearly two orders of magnitude than that of the large-sized GCB (gas circuit breaker). It is because the mass of the movable part is small and the power of a driving mechanism is high. The device is in use extensively in homes or plants. It is termed ‘no fuse breaker’ (NFB) and is mounted on the power receiving side. The NFB has an on-board accident detecting circuit and is able to detect a small current, such as leakage current, up to a large current, such as that flowing in a short-circuiting accident. Meanwhile, a large variety of species of NFBs, up to a voltage of a.c. 600V, may be available. At a voltage higher than 600V, a VCB is routinely used.

### [Patent Document 1]

JP Patent Kokai Publication No. JP-P2002-325355A (FIG. 12)

### [Non-Patent Document 1]

page 8 of a Technical Report of the Institutes of Electrical Engineers, No. 1053, ‘Specifications Required of Current Limiting Circuit Breaker and Techniques for its Evaluation), edited by the Experts Committee for Technical Researches for Fault Detection, May 2006; the original thesis being Ichikawa et al., ‘Field Test of Arc Driving Type Current limiting Circuit Breaker for 6.6 kV Distribution Line’, No. 342, B-Section Meeting of the Institutes of Electrical Engineers, 2001.

### [Non-Patent Document 2]

page 9 of a Technical Report of the Institutes of Electrical Engineers, No. 1053, ‘Specifications Required of Current Limiting Circuit Breaker and Techniques for its Evaluation), edited by the Experts Committee for Technical Researches for Fault Detection, May 2006; the original thesis being a Technical Report of the Institutes of Electrical Engineers, No. 850 ‘Applied Techniques and Analytic Evaluation of Current Limiting Devices for Suppressing Fault Current’, page 4, 2001).

### SUMMARY OF THE DISCLOSURE

The following analysis is given by the present invention. The entire disclosure of Patent Document 1 and Non-Patent Documents 1 to 2 is incorporated herein by reference thereto.

It is an object of the present invention to provide a current-limiting circuit breaker with which it is possible to improve the current-limiting performance and to reduce the size of the device and cost.

The invention disclosed in the present application may be summarized substantially as follows:

In one aspect of the present invention, there is provided a current-limiting circuit breaker comprising:

first and second mechanical switches connected in series with each other;

a first diode, a first snubber circuit and a first current-limiting impedance each connected in parallel across both ends of the first switch, and a second diode; and

a second snubber circuit and a second current-limiting impedance, each connected in parallel across both ends of the second switch. The first and second diodes have anodes connected together, and an anode connection point of the first and second diodes is connected to a connection point of the first and second mechanical switches. The first and second mechanical switches may be NFB high-speed mechanical switches.

In the present invention, a wiring material of higher electrical resistance may be included in each of connection lines that connect the first and second diodes to the first and second mechanical switches, respectively. Or, a resistor of higher electrical resistance may be inserted in each of connection lines that connect the first and second diodes to the first and second mechanical switches, respectively.

In another aspect of the present invention, there is provided a current-limiting circuit breaker comprising:

first and second mechanical switches connected in series with each other;

a current-limiting impedance having one end connected to an end of the first mechanical switch which is not an end thereof connected to the second mechanical switch; the current-limiting impedance having the opposite end connected to an end of the second mechanical switch which is not an end thereof connected to the first mechanical switch; and

a diode and a snubber circuit, each connected in parallel across both ends of the second mechanical switch.

In a further aspect of the present invention, there is provided a current-limiting circuit breaker comprising: first and second mechanical switches connected in series with each other, a diode, a snubber circuit and a current-limiting impedance, each connected in parallel across both ends of the one the first and second mechanical switches.

In a further aspect of the present invention, the current-limiting circuit breaker comprises a plurality of series connected units, each of the units including:

first and second mechanical switches connected in series with each other;

a current-limiting impedance having one end connected to an end of the first mechanical switch which is not an end thereof connected to the second mechanical switch; the current-limiting impedance having the opposite end connected to an end of the second mechanical switch which is not an end thereof connected to the first mechanical switch; and

a diode and a snubber circuit, each connected in parallel across both ends of the second mechanical switch.

In the present invention, at least one of the first and second mechanical switches may be housed in a vessel containing a gas with higher electron absorption.

According to the present invention, at least one of the first and second mechanical switches, the diode and the snubber circuit are housed in a vessel containing a gas with higher electron absorption.

According to the present invention, the vessel may include a wall so that the arc plasma from the first mechanical switch is not contacted with arc plasma from the second mechanical switch. Or, the vessel may include a window opened when the mechanical switch housed in the vessel is in an open state. According to the present invention, the pressure in the vessel is set so as to be higher than the atmospheric pressure.

According to the present invention, the current-limiting impedance may be removed from the current-limiting circuit breaker to form a circuit breaker. In this case, it is unnecessary to provide a breaking switch in series with the series circuit of the first and second mechanical switches.

In a further aspect, the present invention provides a circuit breaker comprising first and second mechanical switches connected in series with each other,

a first diode or a parallel circuit of a first diode and a first snubber circuit, and a second diode or a parallel circuit of a second diode and a second snubber circuit. The first diode or the parallel circuit is connected in parallel across both ends of the first mechanical switch. The second diode or the parallel circuit is connected in parallel across both ends of the second mechanical switch. The first and second diodes have anodes connected together or have cathodes connected together. An anode connection point or a cathode connection point of the first and second diodes is connected to a connection point of the first and second mechanical switches. The first mechanical switch is opened when the current direction is the direction of the forward current of the first diode, with the second mechanical switch being subsequently opened after reversion of the current direction. The second mechanical switch is opened when the current direction is the direction of the forward current of the second diode, with the first mechanical switch being subsequently opened after reversion of the current direction.

In the present invention, at least a portion of a conductor connected to a contact of the mechanical switch may be covered with an insulating cover.

According to the present invention, the surface of the insulating cover facing the mechanical switch and an arc plasma generating area is shielded by a shielding cover.

In a further aspect, the present invention provides a circuit breaker comprising first and second mechanical switches connected in series with each other,
a first diode or a parallel circuit of a first diode and a first snubber circuit, a second diode or a parallel circuit of a second diode and a second snubber circuit, and a series circuit of a switch and a superconducting fault current limiter (SC FCL).

The first diode or the parallel circuit is connected in parallel across both ends of the first mechanical switch, while the second diode or the parallel circuit is connected in parallel across both ends of the second mechanical switch. The first and second diodes have anodes connected together or have cathodes connected together. An anode connection point or a cathode connection point of the first and second diodes is connected to a connection point of the first and second mechanical switches. The series circuit of the switch and the superconducting fault current limiter (SC FCL) is connected in parallel with the series connection of the first and second mechanical switches.

In a further aspect, the present invention also provides a current limiter comprising:

first and second mechanical switches connected in series with each other,

a first diode or a parallel circuit of a first diode and at least one of a first current-limiting impedance and a first snubber circuit, and

a second diode or a parallel circuit of a second diode and at least one of a second current-limiting impedance and a second snubber circuit. The first diode or the parallel circuit is connected across both ends of the first mechanical switch and the second diode or the parallel circuit is connected across both ends of the first mechanical switch. The first and second diodes have anodes connected together or have cathodes connected together. An anode connection point or a cathode connection point of the first and second diodes is connected to a connection point of the first and second mechanical switches.

In a further aspect, the present invention provides a current limiter comprising first and second mechanical switches connected in series with each other, and a diode or a parallel circuit of a diode and at least one of a snubber circuit and a current-limiting impedance. The diode or the parallel circuit is connected in parallel across both ends of one of the first and second mechanical switch.

In yet another aspect, the present invention provides a circuit breaker comprising a series connection of a plurality of units each including first and second mechanical switches connected in series with each other, a current-limiting impedance, a diode connected in parallel with both ends of the second mechanical switch, and a snubber circuit connected in parallel with both ends of the second mechanical switch. The current-limiting impedance has one end connected to an end of the first mechanical switch which is not an end thereof connected to the second mechanical switch. The current-limiting impedance has the opposite end connected to an end of the second mechanical switch which is not an end thereof connected to the first mechanical switch.

According to the present invention, the first mechanical switch is opened in case the current direction is the direction of the forward current of the first diode. The second mechanical switch is subsequently opened after reversion of the current direction. In case the current direction is the direction of the forward current of the second diode, the second mechanical switch is opened, with the first mechanical switch being subsequently opened after reversion of the current direction.

According to the present invention, it is possible to improve the current-limiting performance and to reduce the device size and the cost.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTIONS OF THE DRAWINGS

FIG. 1 is a diagram showing the configuration of a first embodiment of the present invention.

FIG. 2 is a diagram showing the configuration of a second embodiment of the present invention.

FIG. 3 is a diagram showing the configuration of a third embodiment of the present invention.

FIG. 4 is a diagram showing the configuration of a fourth embodiment of the present invention.

FIG. 5 is a diagram showing the configuration of a fifth embodiment of the present invention.

FIG. 6 is a diagram showing the configuration of a sixth embodiment of the present invention.

FIG. 7 is a schematic view showing the configuration of a conventional arc driving type current limiter (cited from page 8 of a Technical Report of the Institutes of Electrical Engineers, No. 1053, ‘Specifications Required of Current Limiting Circuit Breaker and Techniques for its Evaluation), edited by the Experts Committee for Technical Researches for Fault Detection; the original thesis being Ichikawa et al., ‘Field Test of Arc Driving Type Current Limiting Circuit Breaker for 6.6 kV Distribution Line’, No. 342, B-Section Meeting of the Institutes of Electrical Engineers, 2001).

FIG. 8 is a schematic view showing the configuration of a conventional current-limiting circuit breaker of the conventional complex semiconductor type (cited from page 9 of a Technical Report of the Institutes of Electrical Engineers, No. 1053, May 2006, entitled ‘Specifications Required of Current limiting Circuit Breaker and Techniques for its Evaluation’, edited by the Experts Committee for Technical Researches for Fault Detection; the original thesis being a Technical Report of the Institutes of Electrical Engineers, No. 850, entitled ‘Applied techniques and Analytic Evaluation of Current Limiting Devices for Suppressing Fault Current’, page 4, 2001).

FIG. 9 is a schematic view showing the configuration of an arc extinguishing device of an air circuit breaker (p. 755 of ‘Handbook of Electrical Engineering’, Institutes of Electrical Engineers, sixth edition, 2001).

FIG. 10 is a schematic view showing the configuration of an arc extinguishing device of an electro-magnetically actuated air circuit breaker (p. 756 of ‘Handbook of Electrical Engineering’, Institutes of Electrical Engineers, sixth edition, 2001).

FIG. 11 is a diagram showing the configuration of a seventh embodiment of the present invention.

FIG. 12 is a graph showing the relationship between V-I characteristic of a diode and the ON-voltage of a mechanical switch.

FIG. 13 is a diagram showing the configuration of an eighth embodiment of the present invention.

FIG. 14 is a diagram showing a control operation for the eighth embodiment of the present invention.

FIG. 15A is a diagram showing the configuration of a ninth embodiment of the present invention.

FIG. 15B is a diagram showing the configuration of a ninth embodiment of the present invention.

FIG. 16 is a view from a photo showing the configuration of an NFB.

FIG. 17 is a diagram showing the configuration of a ninth embodiment of the present invention.

FIG. 18 is a diagram showing the configuration of a tenth embodiment of the present invention.

### PREFERRED MODES OF THE INVENTION

With reference to the drawings, the present invention will now be described in detail.

### First Exemplary Embodiment

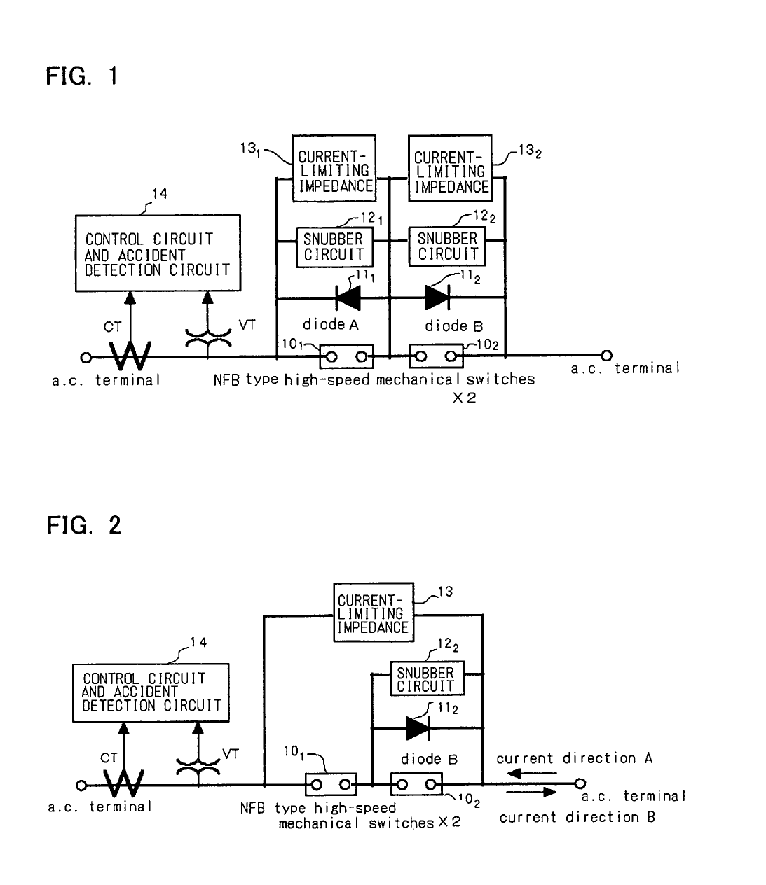

FIG. 1 shows the configuration of an exemplary embodiment of the present invention. Referring to FIG. 1, the present exemplary embodiment is directed to a hybrid type semiconductor current-limiting circuit breaker that makes use of both semiconductor devices and mechanical switches. The high-speed mechanical switches 101 and 102 are connected in series with each other. A diode 111, a snubber circuit 121 and a current-limiting impedance 131 are connected in parallel with the high-speed mechanical switch 101, whilst a diode 112, a snubber circuit 122 and a current-limiting impedance 132 are connected in parallel with the high-speed mechanical switch 102. The diode 111 has its anode connected to the anode of the diode 112. An anode connection point of the diodes is connected to a connection point of the high-speed mechanical switches. In the present embodiment, the high-speed mechanical switches 101 and 102 are formed by NFB high-speed mechanical switches, though not in the meaning of restricting the present invention.

The present exemplary embodiment, shown in FIG. 1, differs from the configuration of FIG. 8 in the following respects.

The present exemplary embodiment uses series-connected high-speed mechanical switches 10 in place of VCBs.

In addition, the present exemplary embodiment uses diodes 11, having anodes connected together, as semiconductor devices, in place of SCRs or GTOs.

With the present exemplary embodiment, making use of the high-speed mechanical switches, the time which elapses since the outbreak of an accident until the start of the current-limiting action may be made shorter. If an SCR is used as a semiconductor device, the start of the current-limiting action since current interruption is only at the next current zero point after the start of current interruption. On the other hand, the mechanical switch is in operation at a higher speed, such that, with a ready-made switch, the current-limiting action occurs at the next half cycle or at the next complete cycle as from the outbreak of the accident. Among known dedicated mechanical switches, there are those in which the current-limiting action may occur in 200 microsecond (us) as from the outbreak of the accident.

In case of using a device which is not of the self-arc-suppressing type, such as SCR, it is unnecessary for the opening operation of the mechanical switch to be shorter than one half cycle. This value has already been achieved with the current-limiting circuit breaker.

With the VCB or a GCB (Generator Circuit Breaker), the circuit opening time of the order of 0.1 to 1.0 second is needed. Hence, the time which elapses since detection of the fault current until the switch is opened is several to scores of cycles, thus increasing the fault current to inflict thermal or mechanical damages to devices that make up a power network.

With the present exemplary embodiment, in which the high-speed mechanical switches are used, the speed of the current-limiting action is higher than with the conventional hybrid type current-limiting circuit breaker of the semiconductor type shown in FIG. 8. The current-limiting circuit breaker has an on-board sensor for detecting the fault current and automatically performs the switch opening action. A ready-made NFB is able to cope with the a.c. voltage up to 600V. To cope with higher voltages, a plural number of NFBs are interconnected in series.

The present exemplary embodiment uses diodes 11, as semiconductor switches, as described above, in place of GTOs, SCRs or IGBTs. Although the diodes exhibit only rectifying action, they may also be arranged as shown in FIG. 1 to implement the current-limiting action. It should be noted that, with the voltage less than the forward voltage VF, no current flows through the diodes. The off-resistance of the diodes (leakage current) is greater than with metal contact switches, such as high-speed mechanical switches (NFBs).

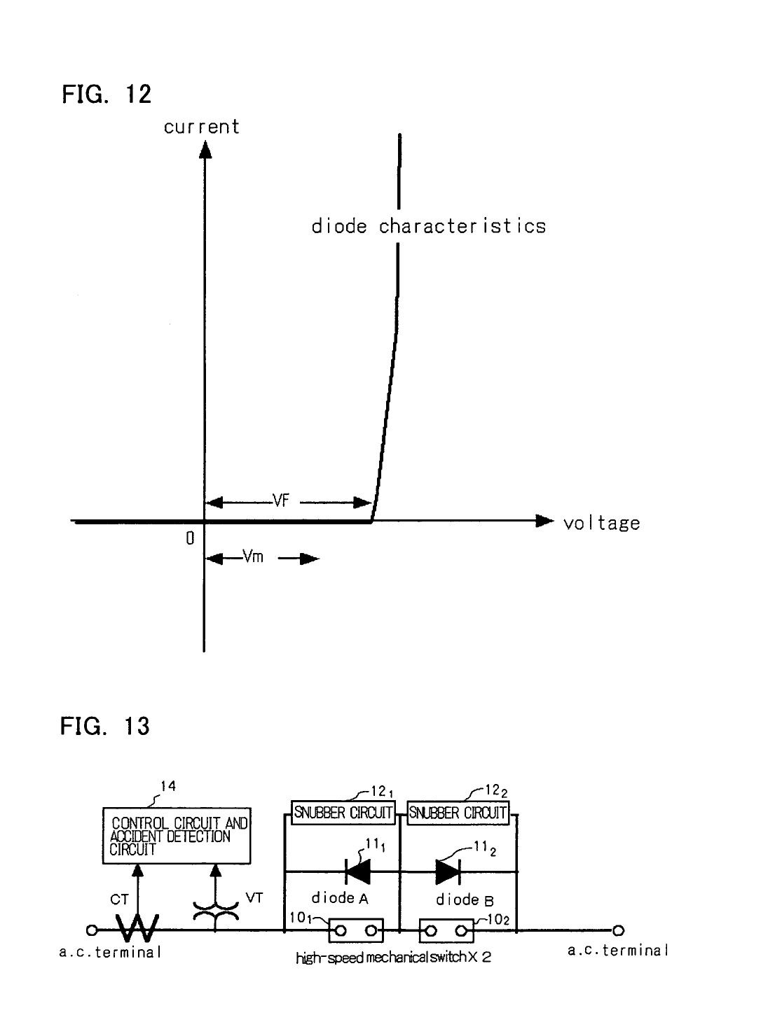

With the conventional configuration, shown in FIG. 8, the current is zero during the normal operation, because no current may flow unless a trigger signal is applied to the semiconductor switch. With the use of the diodes in the present exemplary embodiment, it is possible to reduce the current during the off-time to a value substantially equal to zero. FIG. 12 is a graph showing a V-I characteristic of a diode. Such a diode having a forward voltage VF higher than the contact voltage (ON voltage Vm) of the mechanical switch, as shown in FIG. 12, is selected. The current flows when the voltage applied across the anode and the cathode of the diode exceeds VF. If the ON voltage Vm of the mechanical switch is lower than VF (Vm<VF), no current flows through the diode in the course of the normal operation. That is, the cost for coping with deterioration or heat dissipation of diodes may be reduced appreciably. When the forward voltage VF is low, such a material having a high electrical resistance, such as stainless steel, may be used for the diode side wiring, or a resistor may be connected in series with the diode. In such case, the voltage equal to the contact voltage of the NFB less the voltage drop of the high resistance of the resistor is applied to the diode.

The operation on outbreak of a fault in the present exemplary embodiment is now described. On detection of the fault current, the high-speed mechanical switches are opened. This alone exhibits the current-limiting action, because the arc voltage of the high-speed mechanical switches is higher than with VCB, for instance. In addition, the current is transferred from the side of the high-speed mechanical switch 10 to the side of the diode 11. With the configuration of FIG. 8, the trigger signal needs to be introduced, whereas, with the configuration shown in FIG. 1, the diode automatically commences the commutation process. Thus, with the present exemplary embodiment, the system in its entirety may be improved in reliability.

The time of commutation of the present exemplary embodiment is shorter by not less than one order of magnitude than with the conventional configuration shown in FIG. 8, employing the VCB, for the following two reasons.

The first reason is that the forward voltage of the diode, which is on the order of 0.6V, is a fraction of the ON voltage of the SCR or GTO (2.5V to 3.0V).

The second reason is that the arc voltage of an air breaker is higher by not less than one order of magnitude than that of the VCB.

With the present exemplary embodiment, the current may be transferred more quickly than with the configuration shown in FIG. 8. However, since the circuit of the present exemplary embodiment is an a.c. circuit, commutation occurs only in a diode A (diode 111) or in a diode B (diode 112). In the high-speed mechanical switch, to which the current has been transferred, the current is zero, the electrodes are open and arc plasma therebetween is extinguished. Hence, the insulation voltage across the electrodes is restored.

After lapse of time corresponding to a half cycle, the current flowing direction is reversed. In the diode, to which the current has been transferred, no current flows, because the current flowing direction is reversed. Thus, all current flows through the current-limiting impedance, connected in parallel with the diode, so that the current-limiting action commences. In the diode, where commutation has not occurred, the current commences to be transferred in a similar manner from the high-speed mechanical switch to the diode and, during the next half cycle, all current flows to the current-limiting impedance. Hence, the current-limiting action commences to its fullest extent.

With the present exemplary embodiment, the trigger circuit for the semiconductor switch of the conventional configuration shown in FIG. 8 is not used, thus assuring improved reliability and reduced cost. As regards the cost of the semiconductor device for power use, if the voltage and the current of a diode, an SCR, a GTO, and an ISBT are all of the same values, and the cost for the diode is 1, the cost of the SCR is on the order of 10, while that of the GTO or IGBT is on the order of 30. Thus, with the present exemplary embodiment, cost reduction may be achieved, whereas, with the current-limiting circuit breaker, shown in FIG. 8, the cost is high.

### Second Embodiment

FIG. 2 is a diagram showing the configuration of a second exemplary embodiment of the present invention. Referring to FIG. 2, only the diode B (112) is provided for the high-speed mechanical switch 102. In the present exemplary embodiment, the high-speed mechanical switches 101 and 102 are made up by NFB type high-speed mechanical switches, though not in the sense of restricting the present invention.

The operation of the second exemplary embodiment is now described. During the normal operation, current flows through the high-speed mechanical switches 101 and 102, while no current or only the leakage current flows through the diode B (112), in a manner similar to the first exemplary embodiment shown in FIG. 1.

On detection of the fault current, the two high-speed mechanical switches 101 and 102 are opened, and hence arc plasma is generated across the electrodes of the high-speed mechanical switches. If the current direction at this time point is as indicated by arrow B, the current is transferred to the diode B (112). The arc plasma across the electrodes of the high-speed mechanical switch 102, connected in parallel with the diode B (112), is extinguished.

After lapse of the next half cycle, the current direction is reversed, that is, the current direction is as indicated by arrow A. The current ceases to flow through the diode B (112) to which the current has been transferred. This extinguishes the arc plasma across the electrodes of the high-speed mechanical switch 101, connected in series with the diode B (112), and hence the insulation across the electrodes is restored. Since the current all flows through the current-limiting impedance 13 connected to the diode B (112) to which the current has been transferred, the current-limiting action commences.

At the same time, and also after lapse of the next half cycle, the two high-speed mechanical switches 101 and 102 are both in the open state, and insulation across the electrodes is completely restored. Hence, the current all flows through the current-limiting impedance 13, so that the current-limiting action commences to its fullest extent.

### Third Exemplary Embodiment

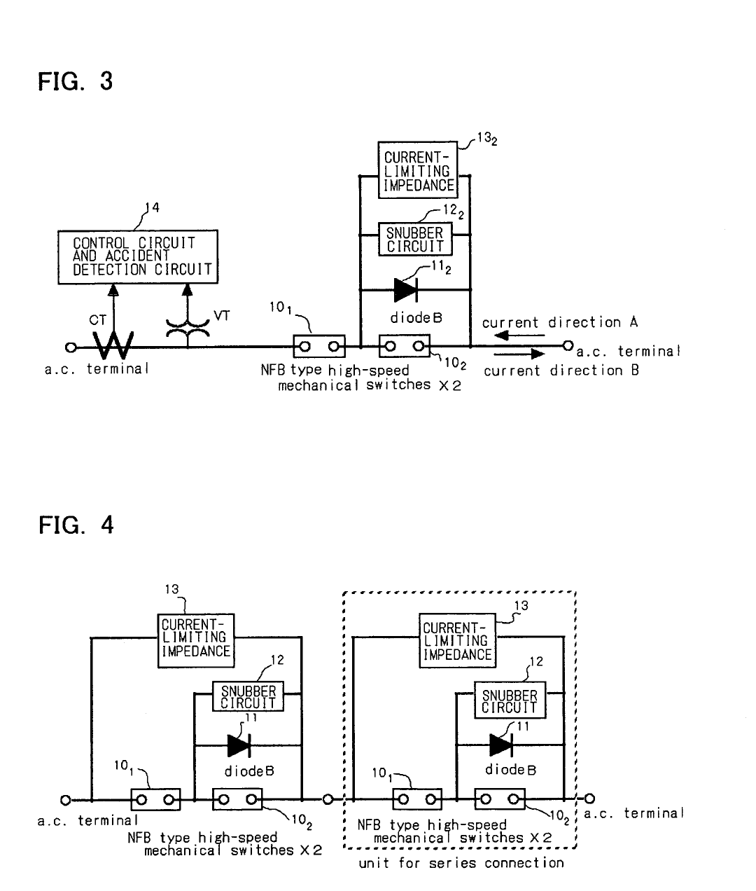

In the exemplary embodiment of FIG. 2, the high-speed mechanical switches 101 and 102 are connected in series with each other, while no diode is connected to the high-speed mechanical switches 101. Hence, the circuit shown is able to interrupt the current completely. This is shown as a third exemplary embodiment in FIG. 3.

In a configuration shown in FIG. 3, the operation during the normal operation is the same as that of FIGS. 1 and 2. On detection of the fault current, the high-speed mechanical switches 101, 102 are opened, and arc plasma is generated across each of the electrodes. If the current flowing direction is as indicated by arrow B, the current commences to be transferred to the diode B (112). If the current flowing direction is the reverse direction, the arc plasma across each of the electrodes of the high-speed mechanical switches is extinguished after one half cycle, and the current flows through the current-limiting impedance 132, so that the current-limiting action commences. In the present exemplary embodiment, the high-speed mechanical switches 101 and 102 are made up by NFB type high-speed mechanical switches, though not in the sense of restricting the present invention.

After lapse of a further half cycle, the current direction is reversed, such that, in FIG. 3, the current flowing direction is as indicated by arrow A. Since the current direction is reversed, no current flows through the diode B (112) to which the current has been transferred. All current flows through the current-limiting impedance 132, and hence the current value decreases appreciably. The current flows through the high-speed mechanical switch 101.

The mechanical switch also has the current interrupting function, and hence is able to interrupt the current at the next zero point, except if there flows a large current.

With the third circuit, the current is interrupted completely, and hence the circuit breaking action at the time of an accident is fulfilled, beginning from the current-limiting action.

In case of using a ready-made high-speed mechanical switch, with a voltage not higher than 600V, the following technique is used to cope with the high voltage:

The configurations of FIGS. 1 and 2 are connected as one set in series with each other. The current-limiting impedances 13 are separately connected for the respective switches. FIG. 4 shows an illustrative configuration. It should be noticed that, in FIG. 4, sensors or control systems for detecting the fault current are not shown.

### Fourth Embodiment

In the exemplary embodiment shown in FIG. 4, in which the high-speed mechanical switches are connected in series with each other, the current-limiting action, which is effective even under a high voltage, may be expected, since the impedances of the arc plasmas of the switches exhibit current-limiting action. In the exemplary embodiment shown in FIG. 4, two units, each including a set of high-speed mechanical switches, exhibiting the current-limiting action, are connected in series with each other, thus redoubling the current-limiting performance as compared to a case of using a sole unit. That is, with the exemplary embodiment shown in FIG. 4, a plurality of units are interconnected in order to cope with the high voltage. When the high-speed mechanical switch is in an open state, a marked current-limiting action may already be expected. In case a plurality of units are interconnected in series with one another, each current-limiting impedance divides the voltage of the unit it is associated with. This needs to be taken into consideration in designing.

If, in the exemplary embodiments shown in FIGS. 2 to 4, the current direction is as indicated by arrow B, the mechanical switch 102 is immediately opened, and the current is transferred to the diode. Hence, the contact of the switch is not damaged. The mechanical switch 101 is opened after reversion of the current direction. Since no current is flowing at this time, the contact of the mechanical switch 101 is not damaged. If it is necessary to interrupt the circuit by limiting the current, and the current flowing direction is A, the above operation is carried out only when the current flowing direction is B after a time corresponding to one-half cycle.

### Fifth Embodiment

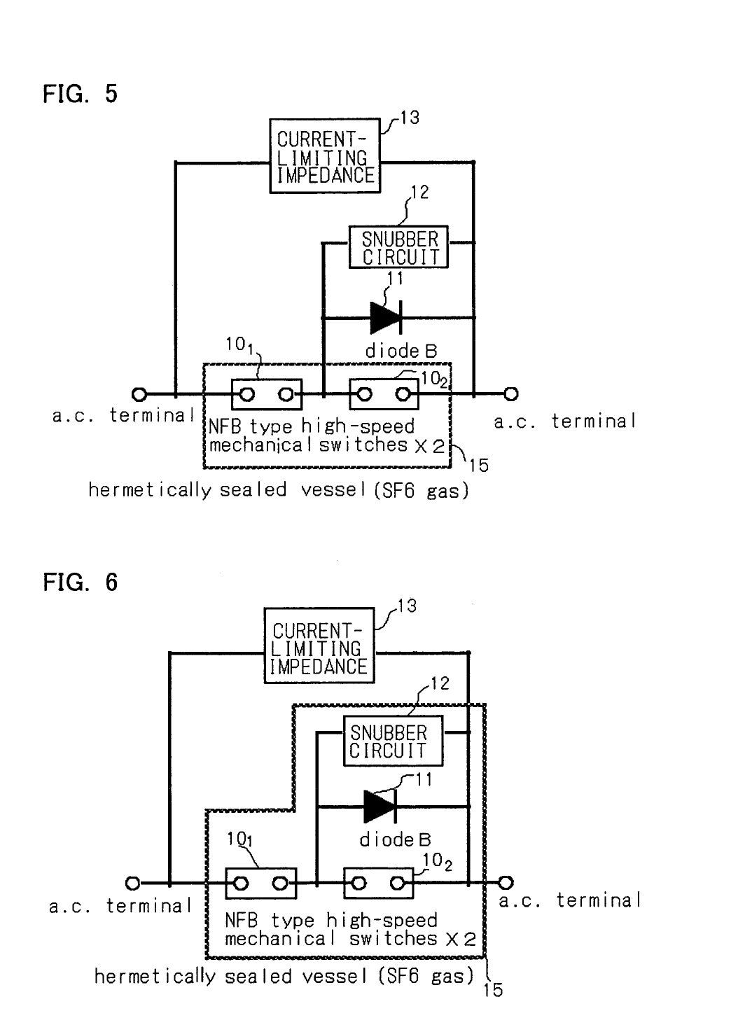

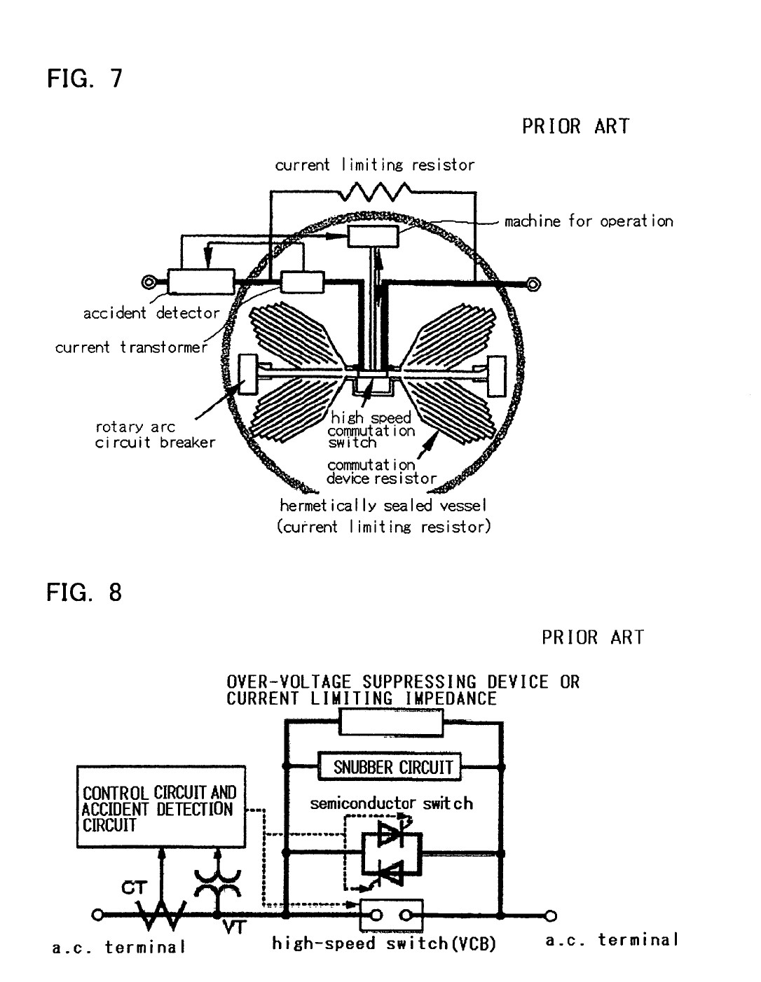

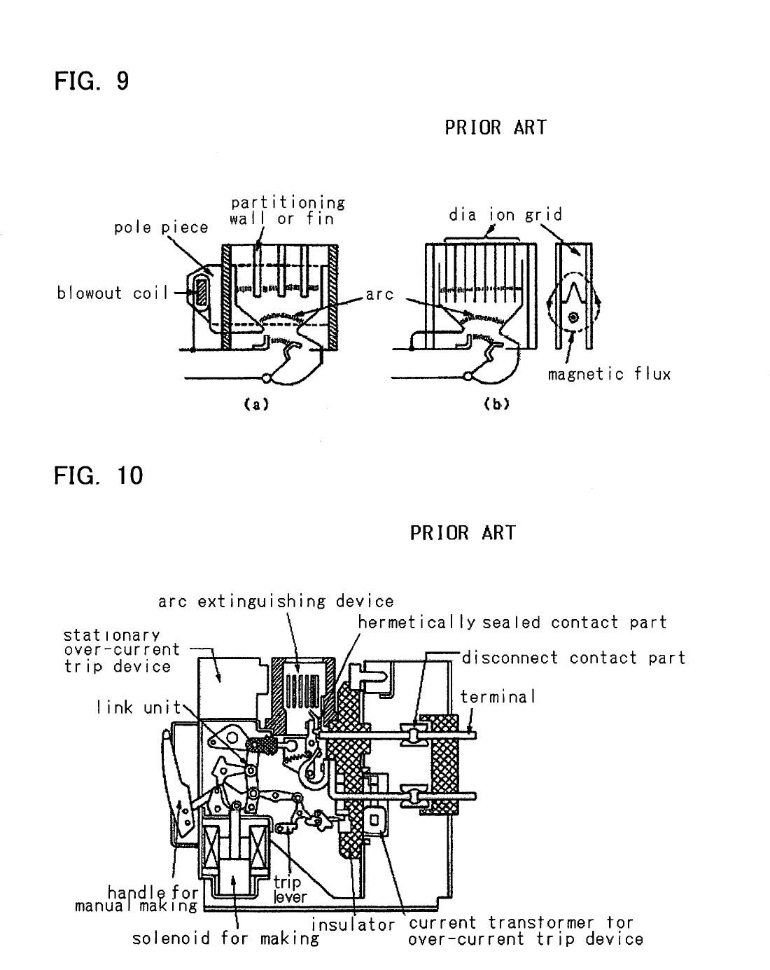

FIG. 5 is a diagram showing the configuration of a fifth exemplary embodiment of the present invention. In the exemplary embodiment of FIG. 5, the high-speed mechanical switches 101 and 102 are housed in a hermetically sealed vessel 15, and a gas exhibiting high electron absorption performance, such as a sulfur hexafluoride gas (SF6) or a nitrogen gas, is sealed in the vessel 15. This improves the electrical insulation performance when no arc plasma gas is generated. In case of generation of arc plasma, the arc voltage is elevated, thus increasing the current-limiting action of the switch itself and providing for a shorter current transfer time to the diode. The gas which is to be contained in the hermetically sealed vessel, and which has higher electron absorption performance, may be exemplified by one of a Fleon gas, a hydrogen gas and an argon gas, or a gas mixture thereof. In the present exemplary embodiment, the high-speed mechanical switches 101 and 102 are made up by NFB type high-speed mechanical switches, though not in the sense of restricting the present invention.

### Sixth Embodiment

FIG. 6 shows the configuration of a sixth exemplary embodiment of the present invention. Referring to FIG. 6, the diode 11 and the snubber circuit 12 may also be sealed in the hermetically sealed vessel 15.

During the current-limiting time, the internal pressure within the hermetically sealed vessel 15 is elevated due to generation of the arc plasma. Hence, a safety value needs to be fitted to the vessel. Also, an insulating material may be used as the vessel material. Since the internal pressure of the vessel is elevated, the hermetically sealed vessel of, for example, a columnar shape, is used.

The SF6 gas is heavier than air, so that, if the high-speed mechanical switch, provided within the vessel, is mounted on the bottom of the vessel (the bottom opposite to the direction of the force of gravity), the probability is high that, even though the gas leakage occurs from the hermetically sealed vessel by some reason or other, the high-speed mechanical switch 10 is immersed within the SF6 gas. The internal pressure may be raised in advance, as in GCB (generator circuit breaker). The arc voltage of the switch, that is, the current-limiting function, and the current interrupting performance, that is, the current interrupting performance at the zero current point, may be improved. It is however necessary that the vessel is formed of stainless steel or the like material to withstand the pressure.

In case the high-speed mechanical switches 101 and 102 are sealed in the hermetically sealed vessel 15, there are two arc plasmas generated within the hermetically sealed vessel 15. If these two arc plasmas contact with each other, there is a possibility that electrical connection is established at such contact point.

In the present exemplary embodiment, the hermetically sealed vessel 15, in which to mount the high-speed mechanical switches 101 and 102, is divided into two parts, or a wall section (barrier wall) is provided within the vessel to prevent the two arc plasmas from contacting each other and to provide for a differential blowing out direction of the arc plasmas out of the high-speed mechanical switches 101 and 102.

It is also possible to provide a window in the hermetically sealed vessel 15 so that the arc plasma is applied to the window. This window may be adapted to be opened when the high-speed mechanical switch is in the open state. By this configuration, the pressure in the hermetically sealed vessel 15 is not raised.

If the pressure within the hermetically sealed vessel 15 is set so as to be higher than the atmospheric pressure, the SF6 gas is sprayed onto the arc plasma to provide for facilitated extinguishment of the arc plasma and for the reliable current-limiting action. In the present exemplary embodiment, the high-speed mechanical switches 101 and 102 are made up by NFB type high-speed mechanical switches, though not in the sense of restricting the present invention.

### Seventh Embodiment

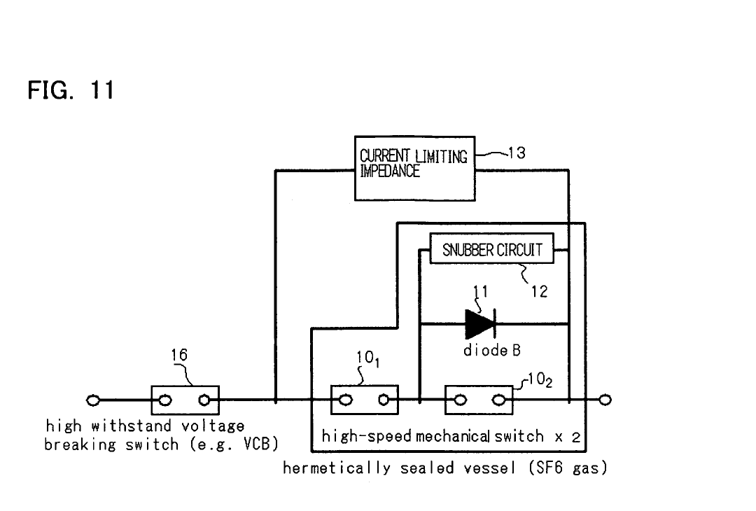

FIG. 11 is a diagram showing the configuration of a further exemplary embodiment of the present invention. Referring to FIG. 11, the present exemplary embodiment corresponds to the configuration of FIG. 2 in which there is further provided a high pressure resistant breaking switch 16 connected in series with the series-connected high-speed mechanical switches 101 and 102. The high pressure resistant breaking switch 16 is made up by a VCB (vacuum circuit breaker) or a GCB (generator circuit breaker). The high pressure resistant breaking switch 16 is opened as necessary, on completion of current-limiting action, to reduce the current flowing through the circuit to zero.

### Eighth Embodiment

FIG. 13 shows the configuration of a further exemplary embodiment of the present invention. Referring to FIG. 13, the present exemplary embodiment corresponds to the configuration of the exemplary embodiment of FIG. 1 less the current-limiting impedances 131 and 132. On occurrence of an accident in the power network, there are cases where a circuit breaking action is sought rather than current-limiting action, or a circuit breaking action is sought in the first place. The circuit breaking action may be achieved by removing the current-limiting impedances 131 and 132 from the configuration of FIG. 1. If the arc across the electrodes of the high-speed mechanical switches 101 and 102 is extinguished, the voltage withstand property is restored and the diodes 111, 112 are able to cope with the reverse voltage, it is possible to break the circuit without introducing the parallel connection of the current-limiting impedances 131 and 132. In similar manner, the circuit interrupting action may be realized by removing the current-limiting impedances from the circuit configuration in each of the above-described exemplary embodiments. In this case, it is unnecessary to provide the breaking switch, such as VCB, of FIG. 11.

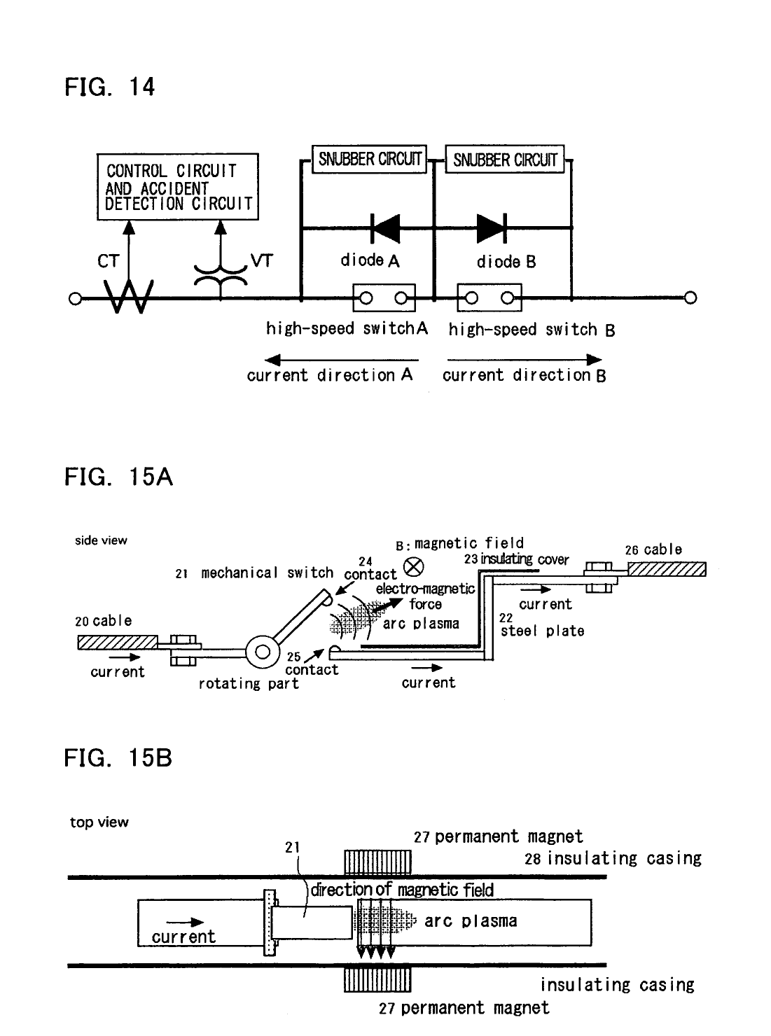

In FIG. 13, the switch opening time may be made variable depending on the current direction. FIG. 14 is similar to FIG. 13 but the direction of the current is additionally shown by arrows. If the current flowing direction is A, the high-speed switch A is opened. The high-speed switch B is subsequently opened with a delay of one half cycle. This decreases damages to and deterioration in a gap between the contacts of the high-speed switch B. If the current flowing direction is B, the high-speed switch B is opened, and the high-speed switch A is then opened with a delay of one half cycle. This decreases damages to and deterioration in a gap between the contacts of the high-speed switch A. The switch connected in parallel with the diode that conducts the forward current is first opened and subsequently the other switch is opened.

### EXAMPLE 9

FIGS. 15A and 15B are schematic views showing the configuration of a further exemplary embodiment of the present invention. Specifically, FIG. 15A and FIG. 15B are a side view and a top plan view of the present exemplary embodiment, respectively. The current flows along a copper plate 22. At the time of circuit interruption, arc plasma is generated across the terminals 24 and 25. An electro-magnetic force is generated by the current flowing through a permanent magnet 27 and the arc plasma. This electro-magnetic force acts for displacing the arc plasma in a direction away from the space between the contacts. Since the direction of the current of the arc plasma is determined by the direction of diode connection, the N and S poles of the permanent magnet 27 are determined accordingly. With the NFB, the copper plate 22, through which flows the current, is exposed to outside atmosphere. Hence, the surface of the copper plate is covered with an insulating cover 23. Or, the copper plate is passed on the underside of an insulating casing 28. A magnetic circuit, not shown, is connected to the permanent magnet 27.

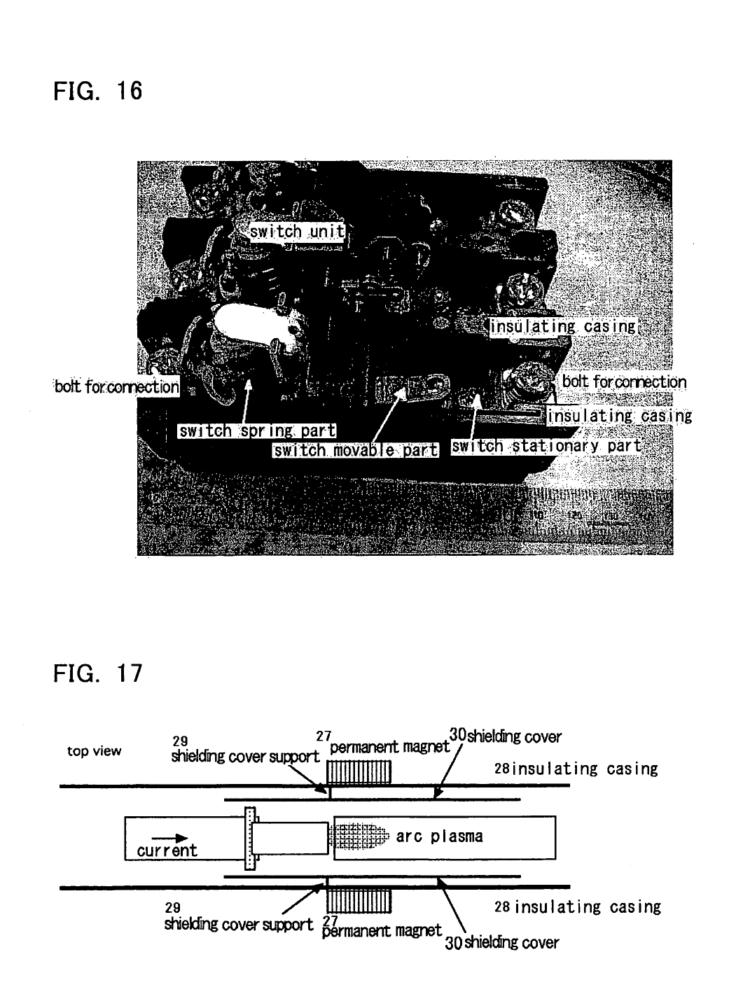

FIG. 16 shows an example of the NFB housed in its entirety in an insulating casing. A mechanical switch includes a movable part (switching part) and a stationary part. A mechanical switch unit includes a switch spring part for driving the movable part. A grid may be used from time to time for extinguishing the arc plasma. However, if the grid material is metal, such as iron, the current breaking performance is deteriorated under an elevated voltage. Hence, the grid is not included in the configuration of FIG. 16. Arc plasma generated across the switching part and the stationary part is liable to deteriorate the insulation performance due to contamination produced by melting of metal or cutting of an insulation casing. That is, the surface of the insulation casing 28 is contaminated by the arc plasma generated at the time of current interruption. To prevent the insulating voltage from being lowered in this manner, a shielding cover 30 is provided in the present exemplary embodiment on the surface of the insulation casing 28, as shown in FIG. 17. The shielding cover 30 is mounted on the insulation casing 28 by a shielding cover support 29, though not in the sense of limiting the present invention. This shielding cover 30 is effective to prevent the surface of the insulation casing 28 from being contaminated by the arc plasma generated at the time of circuit interruption, thereby preventing the insulating voltage on the surface of the insulation casing 28 from being lowered.

### Tenth Embodiment

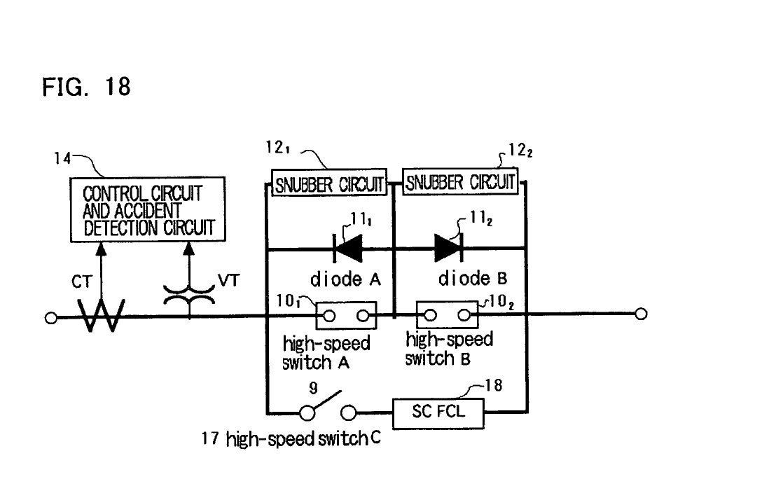

Recently, the development of current limiters exploiting the phenomenon of superconductivity is underway. For example, the Department of Energy (DOE) of U.S.A. is taking up this type of the current limiter as the task of first priority among superconducting equipment related with the electrical power. The principle of superconductivity current limiter resides in the fact that impedance is elevated as a superconductor transitions from superconductivity to normal conduction, thereby limiting the current that is conducted through a circuit. However, this type of the current limiter is unable to break the circuit. Hence, a circuit of FIG. 18 is used to combine this type of the current limiter with a circuit breaker. A diode A and a diode B, having anodes connected together, are connected in parallel with snubber circuits 12, and 122 and high-speed switches A and B (mechanical switches) 101 and 102, respectively. A series circuit of a high-speed switch C and a superconducting fault current limiter (SC FCL) 18 is connected between the cathodes of the diodes A and B in parallel with the series connection of the high-speed switches A and B (101, 102).

In operation, the high-speed switches A, B and C are normally ON, and the superconducting fault current limiter (SC FCL) 18 is also in a superconducting state during the normal operation, and hence in an extremely low impedance state. Hence, the current mostly flows through the SC FCL 18, without flowing through the high-speed switches A and B.

At the time of an accident, the SC FCL 18 transitions to the state of normal conduction to increase the impedance, at the same time as the high-speed switch C is opened. The current then transfers to the high-speed switches A and B. The operation of subsequent interrupting/ driving method is as described above. With the configuration of the present exemplary embodiment, the SC FCL may be built in a fault current limiter.

In FIGS. 1 and 13, for example, the cathodes of the diode 111 and the diode 112 may be connected together at a connection point, which connection point may then be connected to a connection point of the high-speed switches. The snubber circuits may be omitted. In the current limiters of FIGS. 1 and 6, the current-limiting impedances may also be omitted.

Although the present invention has so far been described with reference to preferred exemplary embodiments, the present invention is not to be restricted to the exemplary embodiments. It is to be appreciated that those skilled in the art can change or modify the exemplary embodiments without departing from the spirit and the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A current limiter comprising:
first and second mechanical switches connected in series with each other; and
a diode or a parallel circuit of a diode and a snubber circuit, the diode or the parallel circuit being connected across both ends of at least one of the first and second mechanical switches.

2. The current limiter according to claim 1, comprising a first diode or a parallel circuit of a first diode and at least one of a first current-limiting impedance and a first snubber circuit, the first diode or the parallel circuit being connected across both ends of the first mechanical switch; and
a second diode or a parallel circuit of a second diode and at least one of a second current-limiting impedance and a second snubber circuit, the second diode or the parallel circuit being connected across both ends of the first mechanical switch,
the first and second diodes having anodes connected together or having cathodes connected together, an anode connection point or a cathode connection point of the first and second diodes being connected to a connection point of the first and second mechanical switches.

3. The current limiter according to claim 1, comprising:
a diode or a parallel circuit of a diode and at least one of a snubber circuit and a current-limiting impedance, the diode or the parallel circuit being connected in parallel across both ends of one of the first and second mechanical switches.

4. The circuit breaker according to claim 1, comprising:
a series connection of a plurality of units, the units each including:
the first and second mechanical switches connected in series with each other; and
a diode or a parallel circuit of a diode and a snubber circuit; the diode or the parallel circuit being connected across both ends of the second mechanical switch.

5. The circuit breaker according to claim 1, wherein the first mechanical switch is opened in case the current direction is the direction of the forward current of the first diode; the second mechanical switch being subsequently opened after reversion of the current direction;
the second mechanical switch being opened in case the current direction is the direction of the forward current of the second diode; the first mechanical switch being subsequently opened after reversion of the current direction.

6. A circuit breaker comprising:
first and second mechanical switches connected in series with each other;
a first diode or a parallel circuit of a first diode and a first snubber circuit; the first diode or the parallel circuit being connected in parallel across both ends of the first mechanical switch; and
a second diode or a parallel circuit of a second diode and a second snubber circuit; the second diode or the parallel circuit being connected in parallel across both ends of the second mechanical switch;
the first and second diodes having anodes connected together or having cathodes connected together; an anode connection point or a cathode connection point of the first and second diodes being connected to a connection point of the first and second mechanical switches,
the first mechanical switch being opened when the current direction is the direction of the forward current of the first diode; the second mechanical switch being subsequently opened after reversion of the current direction, and
the second mechanical switch being opened when the current direction is the direction of the forward current of the second diode; the first mechanical switch being subsequently opened after reversion of the current direction.

7. The current-limiting circuit breaker according to claim 6, further comprising an insulating cover covering at least a portion of a conductor connected to a contact of the mechanical switch.

8. The circuit breaker according to claim 7, further comprising a shielding cover shielding a surface of the insulating cover facing the mechanical switch and an arc plasma generating area.

9. A circuit breaker comprising:
first and second mechanical switches connected in series with each other;
a first diode or a parallel circuit of a first diode and a first snubber circuit; the first diode or the parallel circuit being connected in parallel across both ends of the first mechanical switch;
a second diode or a parallel circuit of a second diode and a second snubber circuit; the second diode or the parallel circuit being connected in parallel across both ends of the second mechanical switch,
the first and second diodes having anodes connected together or having cathodes connected together, an anode connection point or a cathode connection point of the first and second diodes being connected to a connection point of the first and second mechanical switches; and
a series circuit of a switch and a superconducting fault current limiter (SC FCL), the series circuit being connected in parallel with the series connection of the first and second mechanical switches.

10. The circuit breaker according to claim 1, comprising:
a first diode, a first snubber circuit and a first current-limiting impedance, each connected in parallel across both ends of the first switch; and
a second diode, a second snubber circuit and a second current-limiting impedance, each connected in parallel across both ends of the second switch,
the first and second diodes having anodes connected together, an anode connection point of the first and second diodes being connected to a connection point of the first and second mechanical switches.

11. The current-limiting circuit breaker according to claim 10, wherein a wiring material of higher electrical resistance is included in each of wirings connecting the first and second diodes to the first and second mechanical switches, respectively.

12. The current-limiting circuit breaker according to claim 10, wherein a resistor of higher electrical resistance is inserted in each of wirings connecting the first and second diodes to the first and second mechanical switches.

13. The circuit breaker according to claim 1, comprising:
a current-limiting impedance having one end connected to an end of the first mechanical switch which is not an end thereof connected to the second mechanical switch, the current-limiting 5 impedance having the opposite end connected to an end of the second mechanical switch which is not an end thereof connected to the first mechanical switch; and
a diode and a snubber circuit, each connected in parallel across both ends of the second mechanical switch.

14. The circuit breaker according to claim 1, comprising:
a diode, a snubber circuit, and a current-limiting impedance, each connected in parallel across both ends of the one of the first and second switches.

15. The circuit breaker according to claim 1, comprising:
a plurality of series connected units, each of the units including:
first and second mechanical switches connected in series with each other;
a current-limiting impedance having one end connected to an end of the first mechanical switch which is not an end thereof connected to the second mechanical switch; the current-limiting impedance having the opposite end connected to an end of the second mechanical switch which is not an end thereof connected to the first mechanical switch; and
a diode and a snubber circuit, each connected in parallel across both ends of the second mechanical switch.

16. The circuit breaker according to claim 1, wherein at least one of the first and second mechanical switches is housed in a vessel containing a gas with higher electron absorption.

17. The circuit breaker according to claim 1, wherein at least one of the first and second mechanical switches, the diode and the snubber circuit is housed in a vessel containing a gas with higher electron absorption.

18. The circuit breaker according to claim 1, wherein at least one of the first and second mechanical switches is housed in a vessel containing a gas with higher electron absorption; and wherein the vessel has a wall so that arc plasma from the first mechanical switch is not contacted with arc plasma from the second mechanical switch.

19. The circuit breaker according to claim 16, wherein the vessel includes a window opened when the mechanical switch housed in the vessel is in an open state.

20. The circuit breaker according to claim 16, wherein a pressure in the vessel is set so as to be higher than an atmospheric pressure.

21. The circuit breaker according to claim 17, wherein the gas with higher electron absorption includes one of a Fleon gas, a hydrogen gas and an argon gas, or a mixture thereof.

22. The circuit breaker according to claim 1, further comprising
a breaking switch connected in series with a series circuit of the first and second mechanical switches,
the breaking switch being set to an open state after completion of current-limiting.

23. The circuit breaker according to claim 1, wherein the first and second mechanical switches include no-fuse breaker type mechanical switches.

24. The circuit breaker according to claim 22, wherein the breaking switch includes a VCB (vacuum circuit breaker) or a GCB (generator circuit breaker).

25. The circuit breaker according to claim 10, from which the current-limiting impedance has been removed.

26. The circuit breaker according to claim 25, in which a circuit breaking effect is carried out without the necessity of providing a breaking switch in series with a series circuit of the first and second mechanical switches.
